(19) United States
(12) Patent Application Publication
(10) Pub. No.: US 2005/0022682 A1
(43) Pub. Date: Feb. 3, 2005

(54) System and method for embossing media

(76) Inventor: James Caron, Solon, OH (US)

Correspondence Address: Patrick D. Floyd, Esq.;Fay, Sharpe, Fagan, Minnich & McKee, LLP, Seventh Floor, 1100 Superior Avenue, Cleveland, OH, 44114-2518, US

(21) Appl. No.: 10/814,003

(22) Filed: Mar. 31, 2004

Related U.S. Application Data
(60) Provisional application No. 60/491,868, filed on Aug. 1, 2003.
(60) Provisional application No. 60/541,480, filed on Feb. 3, 2004.

(51) Int. Cl. B31F 1/07

(52) U.S. Cl. 101/32

(57) ABSTRACT

A system and method of embossing media with an embossing template is provided. The system includes an elastomeric pad which deforms during pressing to spread the press forces over the embossing template. The system can also include a press and a platen plate assembly. The method includes pressing the media, the embossing template and the elastomeric embossing pad in a press to emboss the media with the embossing template. The elastomeric embossing pad deforms during pressing to spread the press forces over the embossing template to create detailed embossings. A wide variety of items can be used as the embossing template to produce a vast array of embossed creations.

### CROSS REFERENCE TO RELATED APPLICATIONS

This application claims the benefit of U.S. Provisional Application No. 60/491,868 filed Aug. 1, 2003 which is hereby incorporated by reference herein and U.S. Provisional Application No. 60/541,480 filed Feb. 3, 2004 which is hereby incorporated by reference herein.

### BACKGROUND

The present invention relates to a system and method of working with media, and more particularly to a system and method of embossing media.

The papercraft and scrapbook industry has become widely popular seeing explosive growth in recent years. Many people have taken up the hobby of keeping mementos and photos in scrapbooks and they wish to personalize their collections using embellished media including embossed papercraft and foils.

Typical systems for embossing media use a press for pressing the media against a die having a three dimensional embossing surface to emboss the media by forming an impression of the embossing surface in the media. In order to form a detailed impression of the embossing surface in the media, the press forces should be spread over the entire embossing surface to push the media against all of its raised and recessed portions.

Known embossing systems use two-piece die sets. These die sets include a male piece having an embossing surface with raised portions and a female piece having an embossing surface with matching recessed portions for receiving the raised portions of the male embossing surface when the dies are pressed together. The media is placed between the male and female die pieces and during pressing, the press forces the male die piece against the media pushing the media into the female die piece thereby forming the impression of the embossing surfaces in the media. Using the male and female two-piece die set spreads the press forces evenly over the surfaces of the media and the dies to create detailed embossings.

However, the two piece die sets used in these longstanding embossing systems are costly. Further, these embossing systems provide only a limited variety of embossings, because they require specialized die sets to form them.

It is desirable to simplify embossing while maintaining the ability to produce detailed impressions of the embossed items. Further, it is desirable to emboss media with a wider variety of objects than just specialized embossing dies.

### SUMMARY OF THE INVENTION

According to the present invention, a new and improved system and method for embossing media is provided.

In accordance with a first aspect of the invention, the system includes an elastomeric embossing pad which deforms during pressing to spread the press forces over the embossing template.

In accordance with a second aspect of the invention, the system can also include a press and a platen plate assembly.

In accordance with a another aspect of the invention, the method includes pressing the media, the embossing template and the elastomeric embossing pad in a press to emboss the media with the embossing template. The elastomeric embossing pad deforms during pressing to spread the press forces over the embossing template to create detailed embossings.

In accordance with yet another aspect of the invention, the method includes stacking a platen plate assembly with the media, the embossing template and the elastomeric embossing pad, and the pressing step includes pressing the media, the embossing template, the elastomeric embossing pad, and the platen plate assembly.

The advantages and benefits of the present invention will become apparent to those of ordinary skill in the art upon reading and understanding the following detailed description of the preferred embodiments.

### BRIEF DESCRIPTION OF THE DRAWINGS

The invention may take form in certain components and structures, preferred embodiments of which will be illustrated in the accompanying drawings wherein:

FIG. 1 illustrates a system for embossing media in accordance with the invention;

FIG. 2 is a perspective view of an embossing pad in accordance with the invention;

FIG. 3 is a perspective view of a platen plate assembly in accordance with the invention; and

FIG. 4 is an enlarged sectional elevational view of a portion of the system shown in FIG. 1.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific examples and characteristics relating to the embodiments disclosed herein are not to be considered as limiting, unless the claims expressly state otherwise.

The term “embellish” as used herein refers to altering the appearance of media by cutting the media and/or by embossing the media. The term “embossing” as used hereinafter refers to forming a three dimensional impression of an embossing template in the media. The embossing template can be a media embellishing die. The term die as used herein refers to a die formed for the express purpose of embellishing media when pressed with a press. The media embellishing die can include a cutter and/or embossing surface for embellishing media. The embossing template can be an embossing die having an embossing surface for embossing media, or it may not be a die, but rather any other three dimensional object capable of embossing media when pressed with the media and the embossing pad as described below. The embossing process is preferably dry embossing that does not use heat. The media can be any material suitable for embellishing including, but not limited to, paper, cardboard, metal, such as for example metal foil or other thin metals, and plastic.

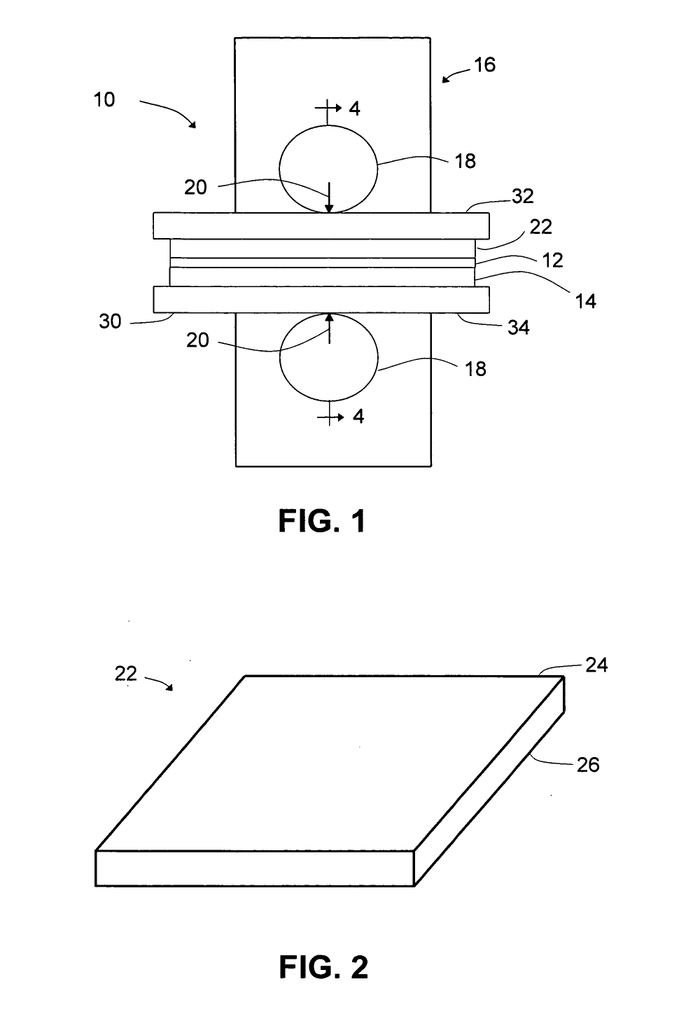

Referring to FIG. 1, a system for embossing media 12 with an embossing template 14 is shown generally at 10. The embossing template 14 can include three dimensional surface detail, including raised portions 40 and/or recessed portions 42 as shown in FIG. 4. The system 10 can include a press 16 having press members 18 for applying press forces, shown by arrows 20, during pressing. The press 16 can be a roller press having one or more rollers for press members 18 as shown. Any other presses capable of generating press forces 20 for pressing the media 12, embossing template 14 and embossing pad 22 can also be used.

The system 10 can further include an embossing pad 22, shown in FIGS. 1 and 2. The embossing pad 22 includes a first surface 24 and a second surface 26. The first and second surfaces 24, 26 are disposed on the opposite sides of the embossing pad 22 and are preferably flat and parallel to each other. The embossing pad 22 is an elastomeric embossing pad formed of a resilient, that is elastic, material which can deform when a force, such as a press force 20, is applied and return to its original shape when the force is removed. Examples of the elastic material forming the elastomeric embossing pad 22 can include, but are not limited to rubber, such as natural rubber including gum rubber, or synthetic rubber, or other materials such as synthetics, polymers, vinyls, urethanes, silicones or any other elastic materials suitable for use as described herein.

The elasticity, that is the amount of deformation the embossing pad 22 can undergo and still return to its original shape, can be defined by the durometer hardness of the pad as measured on the Shore hardness scale as defined by the International Standard of Rubber Hardness. The elastomeric embossing pad 22 can have a hardness, on the Shore hardness scale ranging from about A20 to about A80, and more preferably the embossing pad 22 can have a hardness ranging from about A40 to about A65. The applicability of the elastomeric embossing pad's hardness will be described in detail when describing the operation of the embossing system 10 below.

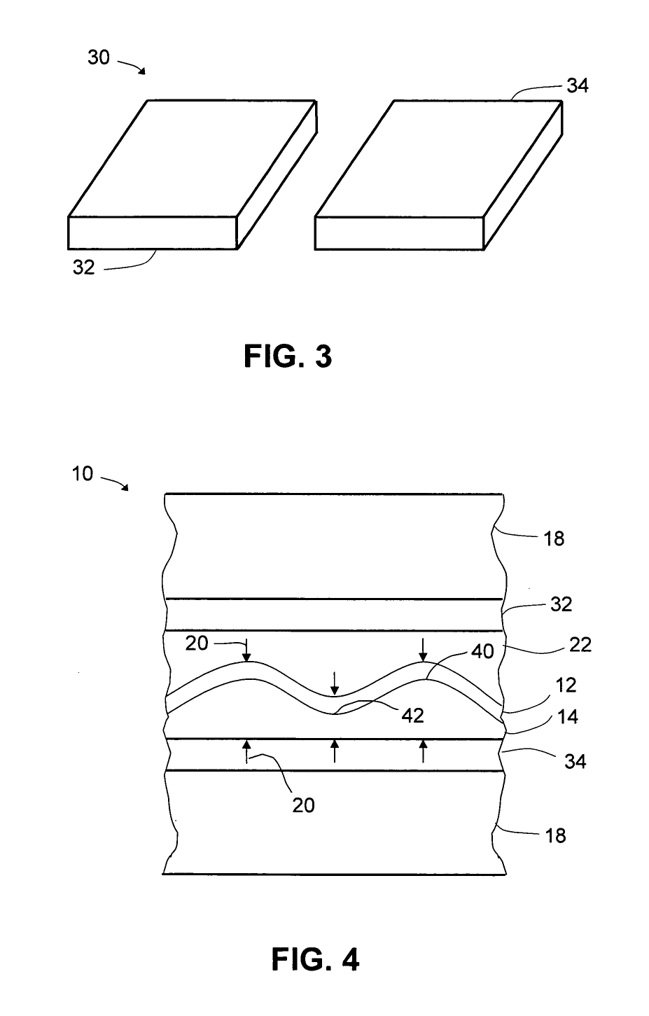

Referring now to FIGS. 1 and 3, the embossing system 10 can further include a platen plate assembly 30 for distributing the press forces 20 when the press members 18 are not generally planar, such as with roller press members used in a roller press. The platen plate assembly 30 can include a first portion 32 and a second portion 34. The first and second portions 32, 34 are each preferably flat. The platen plate assembly 30 is formed of a rigid material, an example of which that should not be considered limiting, includes high density polyethylene. The platen plate assembly 30 can be slightly pliable, and is therefore capable of regularly coming into contact with cutting surfaces without prematurely dulling them. The rigid platen plate assembly 30 is harder than the elastomeric embossing pad 22 and does not deform enough during pressing to spread the press forces 20 over the raised and/or recessed portions 40, 42 of the embossing template 14.

Referring now to FIGS. 1 and 4, the operation of the embossing system 10 for embossing media 12 with an embossing template 14 shall now be described. The media 12 is placed against an embossing template 14, and an elastomeric embossing pad 22 is placed against the media.

The platen plate assembly 30 is then placed between the embossing pad 22 and the press member 18. The media 12 and the embossing template 14 can be placed between the first and second portions 32, 34. However, a platen plate assembly 30 may not be placed between the press member 18 and the embossing template 14 if the template is sufficiently rigid to handle the press forces without bending or deforming enough to distort the embossing. Further, the platen plate assembly may not be used in presses 16 that do not use rollers for press members 18.

The media 12, the embossing template 14, the embossing pad 22 and the platen plate assembly 30 are then pressed in the press 16 generating press forces 20 which press the media and the embossing template together to emboss the media. During pressing, the press forces 20 deform the elastomeric embossing pad 22 causing it to be displaced from the raised portions 40 towards to the recessed portions 42 of the template 14. The deformation of the elastomeric embossing pad 22 spreads the press forces 20 over the media 12 and embossing template 14, including the raised portions 40 and/or the recessed portions 42, to emboss the media. The invention can be effective for presses 16 having press members 18 disposed a fixed distance apart, or press members that reach a fixed distance apart, during pressing, although it can be suitable for other presses as well.

It has been found that the amount of spread of the press forces 20 over the media 12 and embossing template 14, that is how evenly the press forces 20 are distributed, can be adjusted using different elastomeric embossing pads 22 of different hardnesses. Selecting an embossing pad 22 having a lower hardness, such as for example a gum rubber pad having a hardness of about A40 shore results in greater deformation of the embossing pad during pressing thereby increasing the spread of the press forces spreading the press forces more evenly over the raised and/or recessed portions 40, 42 of the template 14. Whereas selecting an embossing pad 22 having a higher hardness, such as for example a vinyl pad having a hardness of A 70 shore, results in less deformation of the embossing pad during pressing thereby decreasing the spread of the press forces, that is spreading the press forces less evenly over the raised and/or recessed portions 40, 42. When press forces are spread less evenly, the press forces are higher at the embossing template's raised portions 40 and the media 12 disposed adjacent thereto, and lower at the embossing template's recessed portions 42 and the media disposed adjacent thereto.

It has also been found that amount of spread of the press forces affects the embossed impression formed in the media 12, also referred to as the embossing. For example, selecting an embossing pad 22 having a lower hardness, resulting in more spread of the press forces 20, produces more detail in the embossing and selecting an embossing pad having a higher hardness, resulting in less spread of the press forces 20, produces less detail in the embossing.

It has also been found that the deformation of the elastomeric embossing pad 22 can reduce the pressure applied to the media 12 and template 14 by the press forces 20 during pressing. More deformation results in a greater reduction of pressure and less deformation results in less of a reduction of pressure. Therefore, it has been found that selecting an elastomeric embossing pad having a lower hardness results in a greater reduction of pressure applied to the media 12 and template 14, and selecting an elastomeric embossing pad having a higher hardness results in less of a reduction of pressure applied to the media 12 and template 14. It has also been found that the impression formed in the media can be changed by selecting the hardness of the elastomeric embossing pad 22. Embossing pads having a higher hardness can be used for templates 14 and/or media 12 requiring more pressure to form the impression and embossing pads having a lower hardness cab be used for templates 14 and/or media 12 requiring less pressure to form the impression.

Using an elastomeric embossing pad 22 in accordance with the invention can create detailed embossings without using a male and female two-piece embossing die. Instead, a simpler, less costly single-piece die can be used as the embossing template 14. Further, using an elastomeric embossing pad 22 in accordance with the invention enables a wide range of three dimensional objects to be used as the embossing template 14, not just dies. Any object that can be pressed with the media in a press can be used as the embossing template 14 to form an impression in the media 12. Examples of such objects include, but are not limited to, keys, chicken wire, paperclips, etc. Therefore the invention enables the user to create a vast array of new embellishments previously unobtainable.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

1. An embossing pad comprising:
an elastomeric pad for use in a press for embossing a media with an embossing template, wherein the elastomeric embossing pad deforms during pressing to spread the press forces over the embossing template.

2. The embossing pad defined in claim 1 wherein the embossing pad has a hardness from about A20 shore to about A80 shore.

3. The embossing pad defined in claim 2 wherein the embossing pad has a hardness from about A40 shore to about A65 shore.

4. The embossing pad defined in claim 1 wherein the embossing pad is formed of rubber.

5. The embossing pad defined in claim 1 wherein the embossing pad is synthetic.

6. The embossing pad defined in claim 1 wherein the embossing pad is formed of vinyl.

7. The embossing pad defined in claim 1 wherein the embossing pad is formed of silicone.

8. The embossing pad defined in claim 1 wherein the embossing pad is formed of a polymer.

9. The embossing pad defined in claim 1 wherein the embossing pad is formed of urethane.

10. The embossing pad defined in claim 1 wherein the embossing pad comprises first and second surfaces disposed opposite each other for placement between a press member and the embossing template.

11. A method of embossing a media with a press comprising:
placing a media against an embossing template;
placing an elastomeric embossing pad having a preselected hardness against the media; and
pressing the media, the embossing template and the embossing pad in the press to emboss the media with the embossing template.

12. The method defined in claim 11 wherein the pressing step includes deforming the elastomeric embossing pad thereby spreading the press forces over the embossing template to emboss the media.

13. The method defined in claim 11 wherein the elastomeric embossing pad has a hardness from about A20 shore to about A80 shore.

14. The method defined in claim 13 wherein the elastomeric embossing pad has a hardness from about A40 shore to about A65 shore.

15. The method defined in claim 11 further comprising selecting the hardness of the elastomeric embossing pad to adjust the amount of deformation of the elastomeric embossing pad thereby adjusting the spread of press forces during the pressing step.

16. The method defined in claim 15 wherein the selecting step comprises selecting an embossing pad having a lower hardness to increase the spread of press forces over the embossing template.

17. The method defined in claim 15 wherein the selecting step comprises selecting an embossing pad having a higher hardness to decrease the spread of press forces over the embossing template.

18. The method defined in claim 11 further comprising selecting the hardness of the elastomeric embossing pad to adjust the amount of deformation of the elastomeric embossing pad thereby adjusting the pressure applied to the embossing template and the media by the press forces during the pressing step.

19. The method defined in claim 18 wherein the selecting step comprises selecting an embossing pad having a lower hardness to reduce the pressure applied to the embossing template and the media by the press forces more than using an embossing pad having a higher hardness.

20. The method defined in claim 18 wherein the selecting step comprises selecting an embossing pad having a higher hardness to reduce the pressure applied to the embossing template and the media by the press forces less than using an embossing pad having a lower hardness.

21. The method defined in claim 11 wherein the embossing template is an embellishing die.

22. The method defined in claim 21 wherein the embossing template is an embossing die.

23. The method defined in claim 11 wherein the embossing template is not a die.

24. The method defined in claim 11 further comprising placing a platen plate assembly against the elastomeric embossing pad, and the pressing step includes pressing the media, the embossing template, the elastomeric embossing pad, and the platen plate assembly.

25. The method defined in claim 24 wherein the platen plate assembly includes first and second portions and the pressing step includes pressing the media, the embossing template, and the embossing pad between the first and second portions.

26. The method defined in claim 24 wherein the platen plate assembly is formed of high density polyethylene.

27. A system for embossing media with an embossing template comprising:
a press having press members for creating press forces for pressing the media against the embossing template; and
an elastomeric embossing pad disposed between the media and the press which deforms during pressing to spread the press forces over the embossing template.

28. The system defined in claim 27 wherein the elastomeric embossing pad has a hardness from about A20 shore to about A80 shore.

29. The system defined in claim 28 wherein the elastomeric embossing pad has a hardness from about A40 shore to about A65 shore.

30. The system defined in claim 27 wherein the elastomeric embossing pad is formed of rubber.

31. The system defined in claim 27 wherein the embossing pad is synthetic.

32. The system defined in claim 27 wherein the embossing pad is formed of vinyl.

33. The system defined in claim 27 wherein the embossing pad is formed of silicone.

34. The system defined in claim 27 wherein the embossing pad is formed of a polymer.

35. The system defined in claim 27 wherein the embossing pad is formed of urethane.

36. The system defined in claim 27 further comprising:
a rigid platen plate for pressing with the media, the embossing template and elastomeric pad.

37. The system defined in claim 36 wherein the platen plate further comprises first and second portions for receiving the media, embossing template and elastomeric embossing pad therebetween during pressing.

38. The system defined in claim 36 wherein the platen plate assembly is formed of high density polyethylene.

39. The system defined in claim 27 wherein the press is a roller press.

40. The system defined in claim 27 wherein the press is not a roller press.

41. The system defined in claim 27 wherein the elastomeric embossing pad deforms reducing the pressure applied to the embossing template and the media by the press forces during pressing.
